(19) United States
(12) Patent Application Publication
(10) Pub. No.: US 2019/0337830 A1
(43) Pub. Date: Nov. 7, 2019

(54) APPARATUS, SYSTEM AND METHOD FOR WASTEWATER TREATMENT

(71) Applicant: Ken Hu, (US)

(72) Inventor: Ken Hu, Newark, DE (US)

(21) Appl. No.: 16/402,105

(22) Filed: May 2, 2019

Related U.S. Application Data
(60) Provisional application No. 62/666,276, filed on May 3, 2018.

(51) Int. Cl. C02F 3/28

(52) U.S. Cl. CPC C02F 3/2833; C02F 2101/163; C02F 3/2826

(57) ABSTRACT

Multiple embodiments are described for water and wastewater treatment using bio-ZVI to remove nitrate, nitrite, perchlorate, chlorinated organic compounds, nitroaromatic compounds, arsenic, selenium, phosphorus, etc. from water. ZVI may also provide an iron nutrient to enhance biological activity, and the oxidized ferric can serve as flocculent to improve sludge dewater characteristics.

### CROSS-REFERENCE TO RELATED APPLICATION

This application is a non-provisional of, and claims priority to, U.S. provisional application Ser. No. 62/666,276, filed May 3, 2018, and entitled “Water and Wastewater Treatment Using Zero Valent Iron (ZVI),” which is hereby incorporated by reference.

### BACKGROUND

The present disclosure is generally directed to methods and apparatuses for addressing current disadvantages in water and wastewater treatment, and, more specifically, is directed to methods and systems for water and wastewater treatment using Biological Zero Valent Iron (bio-ZVI). The bio-ZVI technology can also be used in sponge cities which bio-ZVI is used to clean and filter rain water as well as processed waste water run-off in the wetlands.

### SUMMARY

An aspect of the present disclosure is the removal of at least nitrate (NO₃⁻), nitrite (NO₂⁻) and phosphorus (P) in water using ZVI. Another aspect of the present disclosure is the removal of perchlorate (CL0₄⁻), chlorinated organic compounds such as trichloroethylene (TCE), nitroaromatic compounds, arsenic, selenium, dyes, phenols, and heavy metals using bio-ZVI. A further aspect of the disclosure is enhancing biological activity using ZVI as an iron nutrient and improving sludge dewatering characteristics using the oxidized ferric as a flocculent. Of course, the skilled artisan will appreciate, in light of the discussion herein, the applicability of the disclosed bio-ZVI in other applications in addition to those detailed herein, such as passive filters for water channels or lakes, as well as in so-called “sponge cities”.

### BRIEF DESCRIPTION OF THE DRAWINGS

The exemplary compositions, systems, and methods shall be described hereinafter with reference to the attached drawings, which are given as non-limiting examples only, in which:

FIG. 1 is an illustration of aspects of the embodiments;

FIG. 2 is an illustration of aspects of the embodiments;

FIG. 3 is an illustration of aspects of the embodiments;

FIG. 4 is an illustration of aspects of the embodiments;

FIG. 5 is an illustration of aspects of the embodiments;

FIG. 6 is an illustration of aspects of the embodiments;

FIG. 7 is an illustration of aspects of the embodiments;

FIG. 8 is an illustration of aspects of the embodiments;

FIG. 9 is an illustration of aspects of the embodiments;

FIG. 10 is an illustration of aspects of the embodiments;

FIG. 11 illustrates aspects of the embodiments;

FIG. 12 is an illustration of aspects of the embodiments;

FIG. 13 is an illustration of aspects of the embodiments;

FIG. 14 is an illustration of aspects of the embodiments;

FIG. 15 is an illustration of aspects of the embodiments;

FIG. 16 is an illustration of aspects of the embodiments;

FIG. 17 is an illustration of aspects of the embodiments; and

FIG. 18 illustrates aspects of the embodiments.

### DETAILED DESCRIPTION

The figures and descriptions provided herein may have been simplified to illustrate aspects that are relevant for a clear understanding of the herein described apparatuses, systems, and methods, while eliminating, for the purpose of clarity, other aspects that may be found in typical similar devices, systems, and methods. Those of ordinary skill may thus recognize that other elements and/or operations may be desirable and/or necessary to implement the devices, systems, and methods described herein. But because such elements and operations are known in the art, and because they do not facilitate a better understanding of the present disclosure, for the sake of brevity a discussion of such elements and operations may not be provided herein. However, the present disclosure is deemed to nevertheless include all such elements, variations, and modifications to the described aspects that would be known to those of ordinary skill in the art.

Embodiments are provided throughout so that this disclosure is sufficiently thorough and fully conveys the scope of the disclosed embodiments to those who are skilled in the art. Numerous specific details are set forth, such as examples of specific components, devices, and methods, to provide a thorough understanding of embodiments of the present disclosure. Nevertheless, it will be apparent to those skilled in the art that certain specific disclosed details need not be employed, and that embodiments may be embodied in different forms. As such, the embodiments should not be construed to limit the scope of the disclosure. As referenced above, in some embodiments, well-known processes, well-known device structures, and well-known technologies may not be described in detail.

The terminology used herein is for the purpose of describing particular embodiments only and is not intended to be limiting. For example, as used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The steps, processes, and operations described herein are not to be construed as necessarily requiring their respective performance in the particular order discussed or illustrated, unless specifically identified as a preferred or required order of performance. It is also to be understood that additional or alternative steps may be employed, in place of or in conjunction with the disclosed aspects.

When an element or layer is referred to as being “on”, “engaged to”, “connected to” or “coupled to” another element or layer, it may be directly on, engaged, connected or coupled to the other element or layer, or intervening elements or layers may be present, unless clearly indicated otherwise. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). Further, as used herein the term “and/or” includes any and all combinations of one or more of the associated listed items.

Yet further, although the terms first, second, third, etc. may be used herein to describe various elements, components, regions, layers and/or sections, these elements, components, regions, layers and/or sections should not be limited by these terms. These terms may be only used to distinguish one element, component, region, layer or section from another element, component, region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the embodiments.

Iron is the fourth most abundant element, and modern industry can produce a large quantity of ZVI at a low price. ZVI can be a waste material from industry as well. ZVI, with standard redox potential (E^{O}=−0.44 V), is a strong electron donor for both chemical or bio-chemical reactions. These deductive reactions can be used to remove nitrate, nitrite, perchlorate, chlorinated organic compounds, nitroaromatic compounds, arsenite, selenite, heavy metals, etc., from water. The oxidized iron, such as ferric, is a good coagulant that can remove pollutants, such as phosphorus, and improve sludge dewatering characteristics. The bio-ZVI technology described in the present disclosure may be applied, for example, to both wastewater treatment and drinking water treatment. ZVI may have various particle sizes, shapes and densities that may be selected to perform a combination of functions. ZVI may also provide surface area or nucleation for biofilm formation as a biological carrier. ZVI may provide a ballast to improve solids settleability. ZVI may also provide a substrate for driving bio-chemical and physic-chemical reactions to remove various pollutants from water streams.

The inorganic aspects of the ZVI system make it advantageous for drinking water treatment applications. Nitrate can reduce the ability of red blood cells to carry oxygen. Infants who drink water with high levels of nitrate may develop “blue baby syndrome.” Perchlorate can block iodide uptake by the thyroid. While it is possible to use organic carbon, such as methanol and acetate, as an electron donor to remove nitrate and perchlorate, dosing soluble organic commands and growing a large amount of heterotrophic bacteria in drinking water treatment processes is highly undesired. Autotrophic processes using hydrogen gas as electron donor may be used, but hydrogen gas is very insoluble in water. The autotrophic process typically needs a gas diffusion membrane, also referred to as a Membrane Biofilm Reactor (MBfR). The disclosed ZVI system may be more cost effective than a MBfR process in drinking water applications, at least because there is no need for an expensive membrane system; there is no need for handling hydrogen gas, which is inflammable; and the reactor configurations using ZVI as media can be easily incorporated into drinking water treatment processes.

Without loss of generality, several embodiments of process configurations are described below for both wastewater and drinking water treatment. In general, the ZVI may be introduced to a reactor configuration including, but not limited to, freely flowing suspension, fluidization and packed bed configurations.

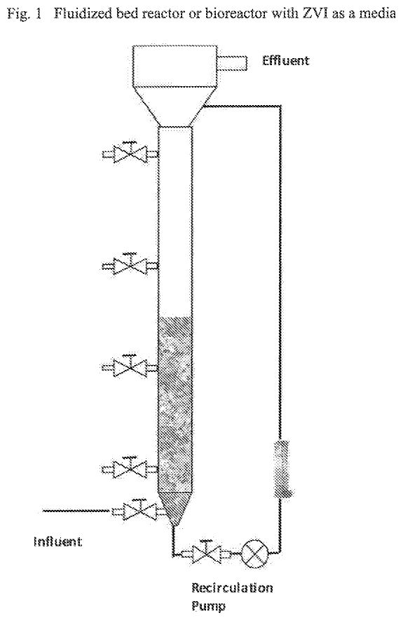

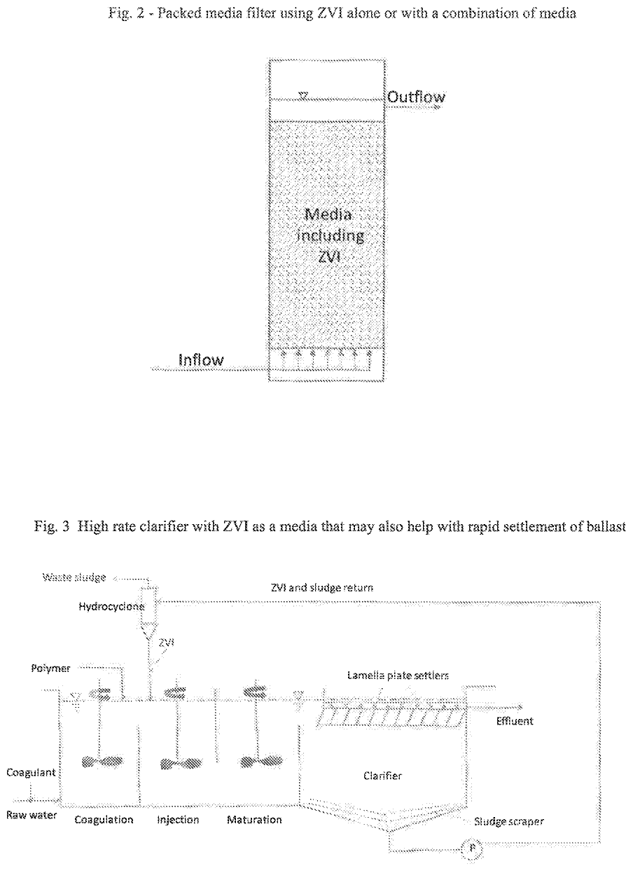

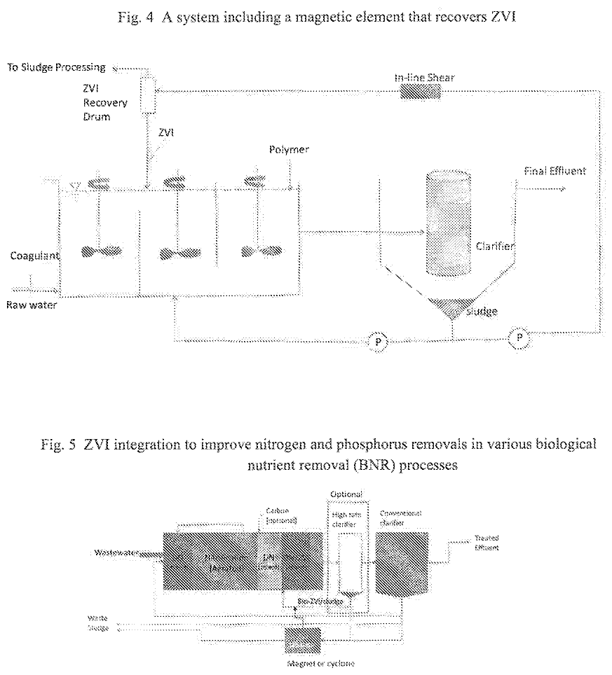

More specifically, various reactor or bioreactor configurations to remove nitrate, nitrite, perchlorate, chlorinated organic compounds, phosphorus, etc., from water are detailed in the disclosure. FIG. 1 illustrates an exemplary fluidized bed reactor. FIG. 2 illustrates an exemplary packed bed reactor with ZVI or ZVI plus other materials as media. FIG. 3 illustrates an exemplary high rate biochemical reactor/settler. FIG. 4 is an example of selectively recovering or separating ZVI from a water matrix using a magnetic element. FIG. 5 illustrates integrating ZVI with a biological nutrient removal system to improve nitrogen and phosphorus removal.

FIG. 1 is an example of a fluidized bed reactor. Water circulation provides hydrodynamic conditions that fluidize the ZVI media in the reactor. When biofilm is grown on the surface of the media, this reactor provides a fluidized bio-reactor. The fluidized reactor may have good mass transfer between the liquid phase and solid phase. Good mass transfer may provide a higher reaction rate. The turbulence and particle collision can also improve control of biofilm thickness. The ZVI media may be retained in the reactor by a settler disposed on the top of the reactor. Other physical methods to retain the media include but are not limited to magnets, lamella tubes or plate settlers, and cyclones.

FIG. 2 is an example of a packed bed reactor, which may also be referred to as a fixed bed reactor. ZVI may provide all of the media or the ZVI may also be mixed with other materials, such as but no limited to sand, wood chips, etc. The reactor may be operated in an upflow mode, downflow mode or a continuous backwash mode. When biofilm grows on the surface of the media, the packed bed reactor may become a packed bed bio-reactor.

FIG. 3 is an example of a high rate clarifier. Without loss of generality, the following description explains one kind of high rate clarifier using ZVI but it will be appreciated that other arrangements for high rate clarifiers may also be used. Raw water enters a coagulation tank with coagulant dosing. Under vigorous mixing conditions, the colloidal substances in the raw water react with the coagulant. The coagulated water enters the second injection tank, where polymers and ZVI particles are added. The polymer promotes flocculation, and heavy ZVI particles may be embedded into floes.

Slower mixing is provided in the third maturation tank, where the floe size increases. Then, the water enters the clarifier. The floe including heavy ZVI particles settles to the bottom of the clarifier. Lamella plates may be disposed at the upper part of the clarifier, which can improve settling of smaller or lighter flow. The sludge scraper pushes the sludge towards the center of the clarifier, which is eventually pumped out to a hydrocyclone unit. The sludge and ZVI particles are separated in the hydrocyclone, where the underflow with heavy ZVI particles is recycled back into the injection tank. In this way, the ZVI particles may be reused. The hydrocyclone overflow with lighter waste sludge may leave the system.

ZVI may provide ballast particles to increase the settling velocity of the floes. ZVI may also serve as an electron donor. Chemical or biochemical reactions can take place mainly in the injection and maturation tanks, as well as the clarifier. These chemical or biochemical reactions help remove nitrate, nitrite, phosphorus perchlorate, chlorinated organic compounds such as trichloroethylene (TCE), nitroaromatic compounds, arsenic, selenium, dyes, phenols, heavy metals, etc., from the water. The turbulence in the injection and maturation tank may improve the solids/liquid interface mass transfer and the reaction rate. It will be appreciated that ZVI can be used in combination with other ballast materials such as but not limited to sand.

FIG. 4 is an example of a magnetic system that recovers ZVI. As an example, the system is illustrated as a high rate clarifier similar to FIG. 3, where the heavy ZVI particles serve as ballast particles to increase the settling velocity of the floes, and the ZVI particles provide an electron donor for various chemical or biochemical reactions which help remove nitrate, nitrite, phosphorus perchlorate, chlorinated organic compounds, nitroaromatic compounds, arsenic, selenium, dyes, phenols, heavy metals, etc. from the water. The sludge from the clarifier is pumped through an in-line shear device, and the sludge/ZVI mixture enters the magnetic ZVI recovery system. The ZVI particles interact with the magnetic field and are recovered and recycled to one of the reaction tanks. The non-magnetic sludge particles may leave the system. The above description and FIG. 4 are illustrative in nature and the magnetic system may also be included in other reactor design configurations to recover ZVI.

FIG. 5 is an example of an integrated bio-ZVI solution to improve nitrogen and phosphorus removal in a biological nutrient removal (BNR) process. The four-stage Bardenpho process is an example of a biological nitrogen removal process comprised of anoxic, aerated, post anoxic and reaeration zones. The post anoxic zone provides nitrogen polishing to low levels. Biodegradable organic carbon compounds may be dosed to the post anoxic zone as an electron donor for heterotrophic denitrification (DN). Autotrophic biofilm may develop on the ZVI to facilitate denitrification. The development of the autotrophic biofilm on the ZVI may be promoted by limiting or excluding organic carbon in the post anoxic zone. Using ZVI as an electron donor limits or avoids carbon dosing, which may lower biological sludge production and allow for treatment to be performed using a smaller reactor size. To limit or prevent ZVI media from entering other bioreactor zones, a high rate clarifier may be disposed between the bioreactor and clarifier to capture the ZVI. A magnetic or cyclone ZVI separator may be used at the waste sludge stream to reduce ZVI loss in the waste activated sludge. A floe shearing device may be disposed before the separation of ZVI.

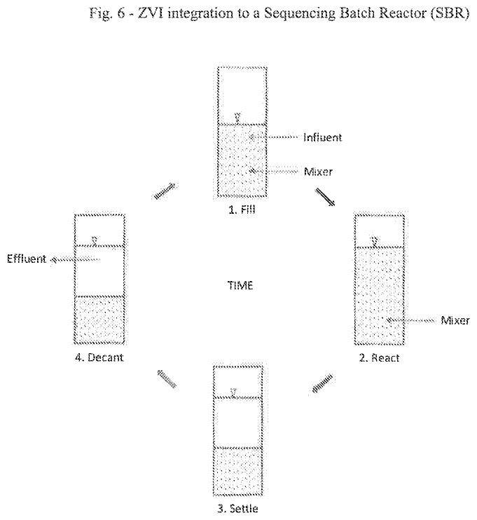

FIG. 6 is an example of integrating ZVI into an exemplary Sequencing Batch Reactor (SBR). Without loss of generality, the SBR reactor can be operated as 4 phases: (1) Fill, (2) React, (3) Settle and (4) Decant. During the fill and react phases, mechanical mixer(s) in the reactor are running to keep the ZVI and other particles in suspension. During the settle and decant phases, the mechanical mixer(s) are stopped. In this way, the influent enters the reactor, the pollutants in the influent are removed in the ZVVSBR reactor, and eluent leaves the reactor. The chemical or bio-chemical reaction may taking place in both fill and react phases, making it is possible to reduce or eliminate the react phase. ZVI particles are heavy, the settling velocity is faster than biological sludge, and the settle phase can be reduced compared to conventional techniques. Furthermore, the ZVI can improve the compactness of the solids blankets, and a larger volume of supernatants can be decanted out. These factors may individually and/or collectively increase the treatment capacity of a SBR reactor. The SBR embodiment may include a continuous flow SBR and other variations of SBR reactors. ZVI may provide an iron nutrient to enhance biological activity, and the oxidized ferric can serve as flocculent to improve sludge dewaterability characteristics.

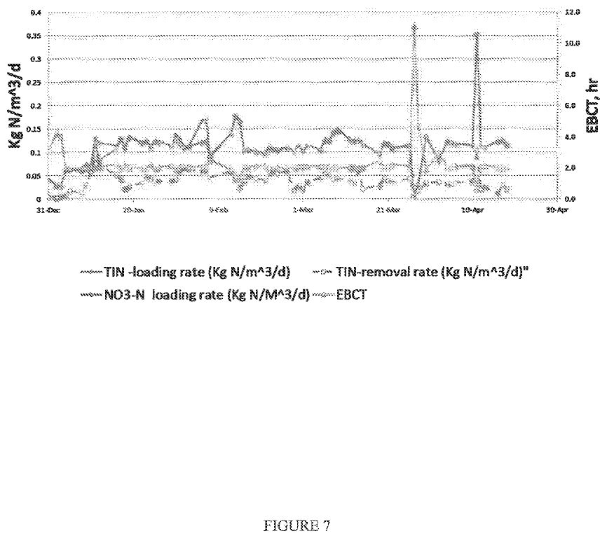

FIG. 7 shows an example of the nitrogen loading and removal rate per cubic meter of a packed bed bio-ZVI reactor per day. Total inorganic nitrogen includes ammonia nitrogen (NH3-N), nitrate nitrogen (N03-N) and nitrite nitrogen (N02-N). These tests were conducted with an empty bed contact time (EBCT) of about 2 hours. Since most of the reactor volume was occupied by ZVI and other media, the true contact time in the reactor was about 30 minutes.

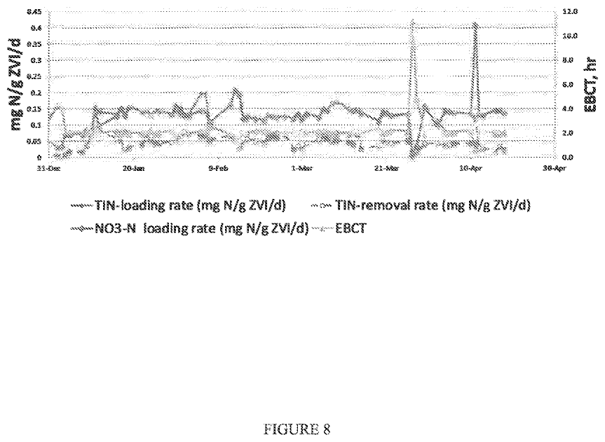

In addition to the nitrogen removal per volume of reactor, the nitrogen removal per gram of ZVI media may also be an important performance factor. FIG. 8 shows an example of the milligrams of nitrogen loaded and removed by per gram of ZVI media per day.

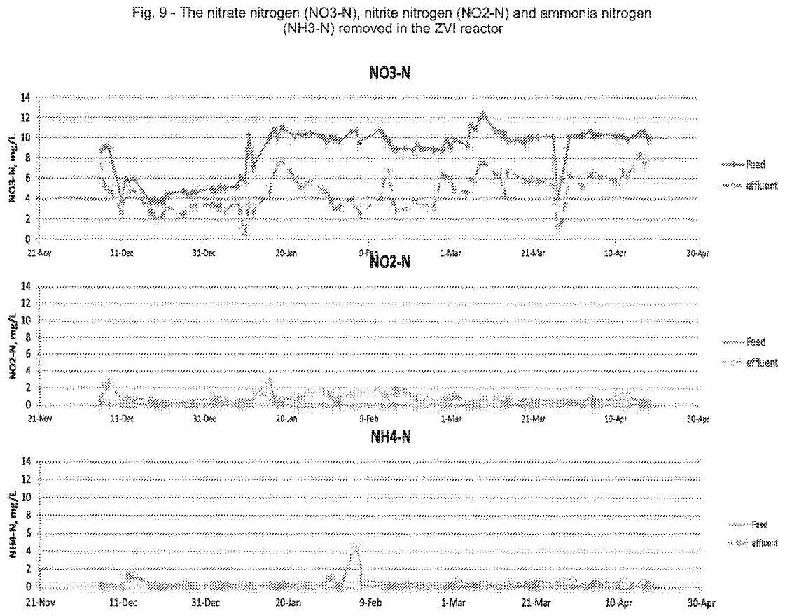

FIG. 9 shows exemplary detail information for nitrate nitrogen (N03-N), nitrite nitrogen (N02-N) and ammonia nitrogen (NH3-N) removed in an exemplary bio-ZVI reactor. The data shows most of the nitrate was removed from the water as nitrogen gas, because there was little increase of nitrite nitrogen and ammonia nitrogen (NH3-N). The total inorganic nitrogen removal percentage data is shown in FIG. 10.

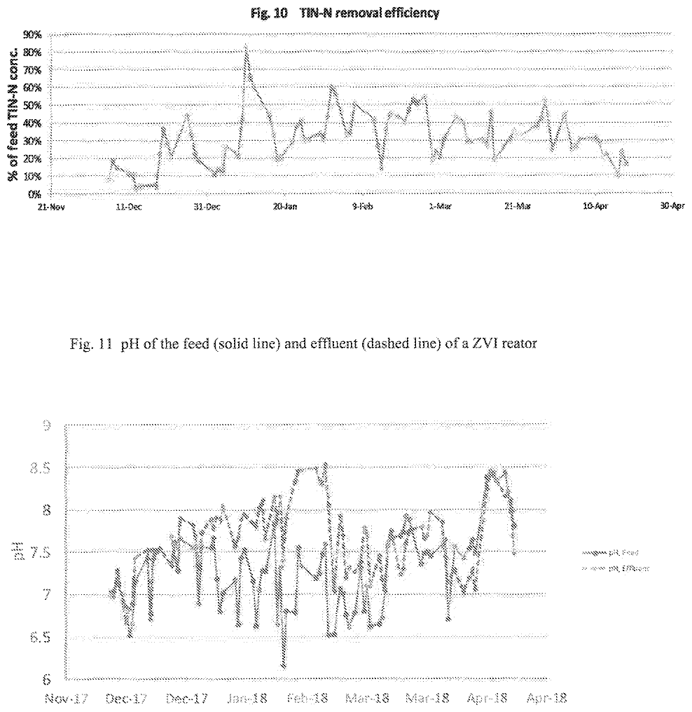

Because de-nitrification can generate alkalinity, the effluent water can have a slightly higher pH value than the pH of influent. (Shown in FIG. 11).

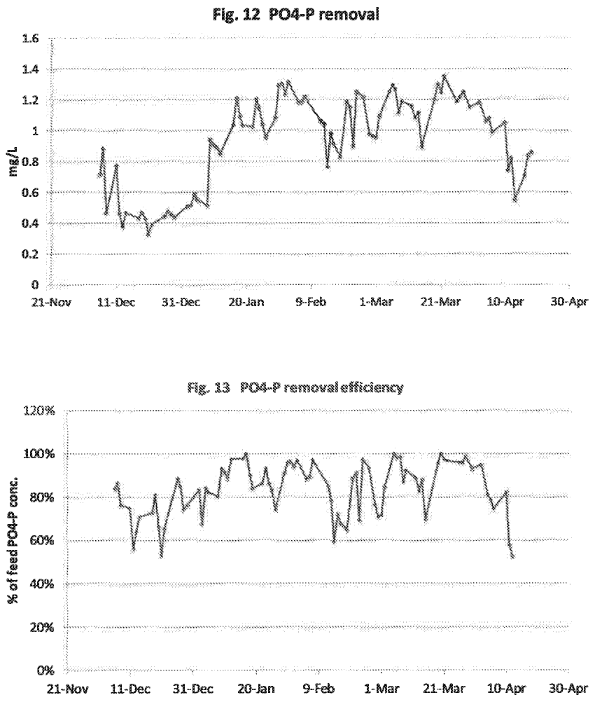

As described above, a ZVI reactor can remove many pollutants from the water simultaneously. For example, orthophosphate (P04-P) removed in the ZVI reactor is shown in FIG. 12, and orthophosphate removal efficiency is shown in FIG. 13.

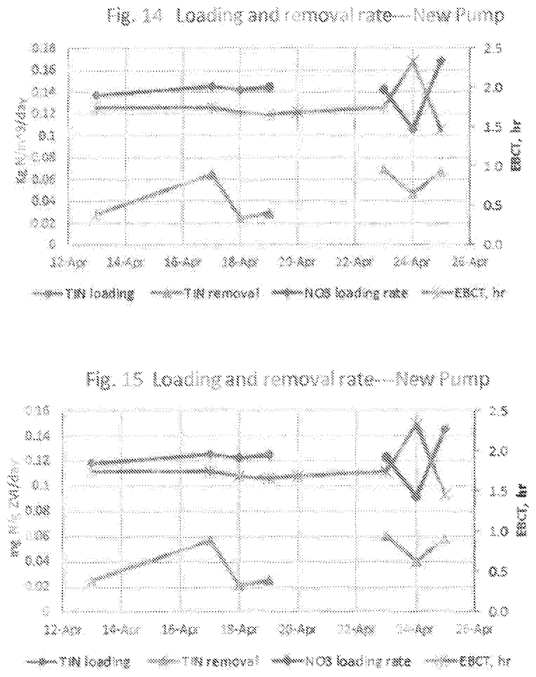

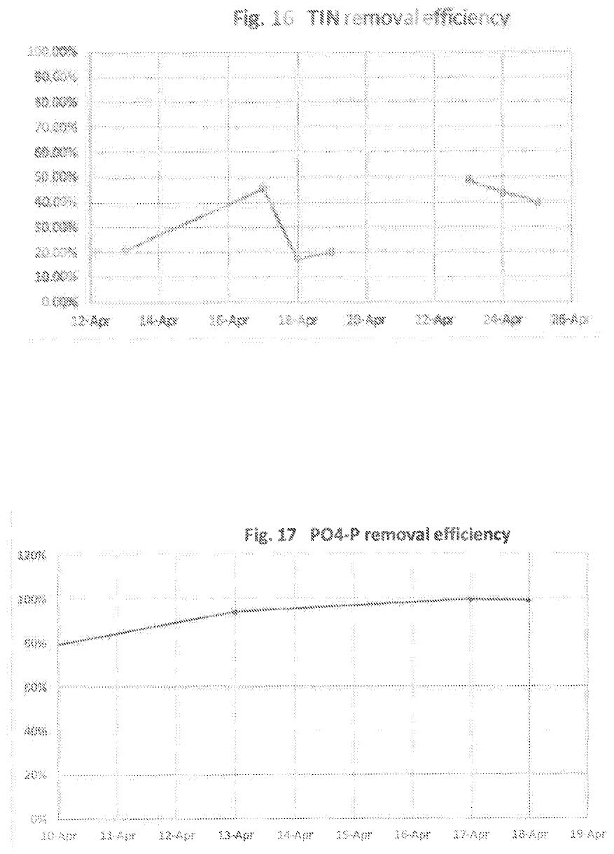

FIG. 14 shows the nitrogen loading and removal rate per cubic meter of an exemplary fluidized bed ZVI reactor per day. FIG. 15 shows the milligrams of nitrogen loaded and removed by per gram of ZVI media every day. The total inorganic nitrogen removal efficiency is shown in FIG. 16, and the orthophosphate removal efficiency is shown in FIG. 17.

Total inorganic carbon (IC) may be measured along the length of the packed bed reactor to verify that the de-nitrification is autotrophic (not using organic carbon as carbon source). The total inorganic carbon includes the dissolved C02, HC03⁻ and C03²⁻ in the water. Heterotrophic de-nitrification may consume organic carbon compounds, which may use the energy that they obtain from organic food for growth and to produce C02. In the case where de-nitrification is mainly heterotrophic, organic carbon converts to inorganic carbon, and a significant increase of inorganic carbon may be observed along the length of the packed bed reactor.

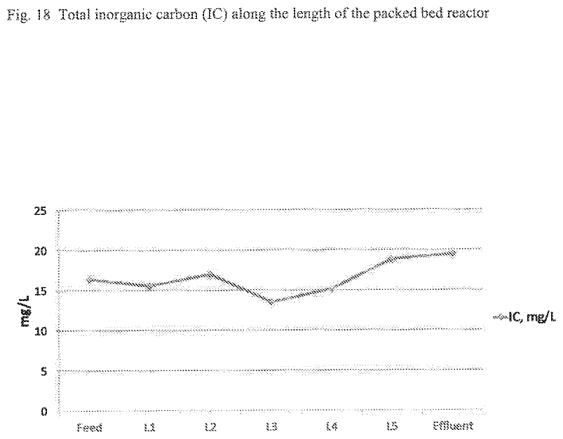

FIG. 18 is an example of the measured data. In the exemplary data shown in FIG. 18, there is not a significant increase of inorganic carbon concentration along the length of the packed bed reactor, which indicates that the de-nitrification is not heterotrophic, and autotrophic.

Another test that may be performed to determine whether the de-nitrification is autotrophic is a “spike” test in which sodium acetate is temporarily added in the feed water to increase the organic food. The total organic carbon (TOC) and total inorganic carbon (IC) profile may be measured. If there is not significant conversion from organic carbon to inorganic carbon, then the test indicates that the de-nitrification is autotrophic. In another test, a water sample is taken from the middle of a ZVI reactor. The concentration of dissolved H2 is measured. If dissolved H2 is detected, the test indicates that the de-nitrification is autotrophic.

In the foregoing detailed description, it may be that various features are grouped together in individual embodiments for the purpose of brevity in the disclosure. This method of disclosure is not to be interpreted as reflecting an intention that any subsequently claimed embodiments require more features than are expressly recited.

Further, the descriptions of the disclosure are provided to enable any person skilled in the art to make or use the disclosed embodiments. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but rather is to be accorded the widest scope consistent with the principles and novel features disclosed herein.

What is claimed is:

1. A wastewater treatment apparatus, comprising:
at least one reaction chamber comprising at least one inflow of the wastewater and at least one outflow; and
zero valent iron disposed in the at least one reaction chamber and being suitable for treating the inflow prior to the outflow.

2. The wastewater treatment apparatus of claim 1, wherein the at least one reaction chamber comprises a fluidized bed reactor.

3. The wastewater treatment apparatus of claim 2, wherein the fluidized bed reactor comprises a settler atop thereof, which includes the zero valent iron.

4. The wastewater treatment apparatus of claim 3, wherein the zero valent iron is media-tized.

5. The wastewater treatment apparatus of claim 1, wherein the at least one reaction chamber comprises a packed bed reactor.

6. The wastewater treatment apparatus of claim 1, wherein the at least one reaction chamber comprises a high rate clarifier.

7. The wastewater treatment apparatus of claim 1, wherein the expended zero valent iron is recoverable.
